(19) United States
(12) Patent Application Publication
(10) Pub. No.: US 2012/0226475 A1
(43) Pub. Date: Sep. 6, 2012

(54) SUBSTRATE PROCESSING SYSTEM, MANAGEMENT APPARATUS, DATA ANALYSIS METHOD

(75) Inventor: Kazuhide Asai, Toyama-shi (JP)

(73) Assignee: HITACHI KOKUSAI ELECTRIC INC., Tokyo (JP)

(21) Appl. No.: 13/402,294

(22) Filed: Feb. 22, 2012

(30) Foreign Application Priority Data
Mar. 3, 2011 (JP) 2011-046633

(51) Int. Cl. G06F 17/18

(52) U.S. Cl. 702/179

(57) ABSTRACT

A substrate processing system including a management apparatus, the management apparatus including: a substrate processing apparatus configured to process a substrate; an accumulation unit configured to accumulate measurement data transmitted from the substrate processing apparatus; a storage unit configured to individually store an item of the measurement data regarding an operation state of the substrate processing apparatus, a type of statistics applied to the measurement data, and a condition used for determining the statistics; and an extraction unit configured to extract a combination of data for which the measurement data accumulated in the accumulation unit is determined to be abnormal, with respect to a combination of data including the item of the measurement data, the statistics, and the condition stored in the storage unit.

### CROSS-REFERENCE TO RELATED APPLICATIONS

This application is based upon and claims the benefit of priority from Japanese Patent Application No. 2011-46633, filed on Mar. 3, 2011, the entire contents of which are incorporated herein in their entirety by reference.

### TECHNICAL FIELD

The present disclosure relates to a substrate processing system including a substrate processing apparatus and a management apparatus for managing processes performed by the substrate processing apparatus.

### BACKGROUND

In the field of semiconductor manufacturing, semiconductor production efficiency can be enhanced using a group management system capable of monitoring production history or an operation state of a semiconductor manufacturing apparatus. Also, fault detection and classification (FDC) is executed based on stored monitor data (measurement data regarding the operation state of the semiconductor manufacturing apparatus) to determine whether the apparatus is operating in normal conditions. Any abnormality is identified using alarms to prevent defective manufacturing. Further, for abnormality detection based on FDC, a method using a statistical process control (SPC) has been proposed.

In addition, the related art FDC adopts a method in which an experienced operator assumes a combination (or pattern) of data indicating a cause of an abnormality in film formation (a film formation abnormality) based on his experience, analyzes monitor data based on the pattern, creates a plurality of candidates of the pattern (content) to be used in the FDC, and selects only valid content among the candidates of the content by using an elimination method based on an evaluation afterwards.

For example, when executing FDC monitoring based on such content, if an abnormality is found in the film forming process, the current content becomes invalid and should be deleted or adjusted.

As used herein, a film formation abnormality refers to an abnormality found in checking the quality of film formed on a surface of a substrate (wafer) by the substrate processing. Thus, since monitor data does not directly indicate a film formation abnormality, the monitor data is required to be analyzed for the film formation abnormality.

As discussed above, if a film formation abnormality occurs, related contents are re-evaluated and more appropriate content is reproduced if necessary. However, there are problems in that this process requires significant time and labor, which results in significant time required until an actual operation of the FDC starts.

### SUMMARY

The present disclosure provides some embodiments of a method for creating optimum content in order to monitor an abnormality (e.g., a film formation abnormality) requiring analysis of monitor data.

According to one embodiment of the present disclosure, there is provided an management apparatus comprising: an accumulation unit configured to accumulate measurement data regarding an operation state of a substrate processing apparatus; a storage unit configured to individually store the measurement data, a type of statistics applied to the measurement data, and a condition used for determining the statistics; and an extraction unit configured to extract a combination of data for which the measurement data accumulated in the accumulation unit is determined to be abnormal, with respect to a combination of data including the measurement data, the statistics, and the condition stored in the storage unit.

In another embodiment, there is provided a substrate processing system including a substrate processing apparatus connected to the aforementioned management apparatus.

In yet another embodiment, there is provided a data analysis method comprising: collecting measurement data regarding an operation state of a substrate processing apparatus; and extracting a combination of data for which the measurement data is determined to be abnormal in a predetermined time range, among the collected measurement data, with respect to a combination of data including the measurement data, a statistics applied to the measurement data, and a condition used for determining the statistic.

### BRIEF DESCRIPTION OF THE DRAWINGS

FIG. 1 is a perspective view of a substrate processing apparatus according to a first embodiment of the present disclosure.

FIG. 2 is a side sectional view of the substrate processing device apparatus according to the first embodiment of the present disclosure.

FIG. 3 is a vertical sectional view of a processing furnace of the substrate processing apparatus according to the first embodiment of the present disclosure.

FIG. 4 is a block diagram of the substrate processing apparatus according to the first embodiment of the present disclosure.

FIG. 5 is a graph showing representative value data in time series according to the first embodiment of the present disclosure.

FIG. 6 is an SPC graph in a film forming step according to the first embodiment of the present disclosure.

FIGS. 7A, 7B and 7C are explanatory views showing a method of extracting an abnormality pattern according to the first embodiment of the present disclosure, in which FIG. 7A is an SPC graph in a film forming step, FIG. 7B shows a monitor data table, a statistic table, and an abnormality determination rule table, and FIG. 7C shows an abnormality pattern table.

FIGS. 8A, 8B and 8C are views explaining a difference between an abnormality pattern extraction unit and an abnormality predictive pattern extraction unit according to the first embodiment of the present disclosure, wherein FIG. 8A is a graph showing a data line as a target of analysis by the abnormality pattern extraction unit, FIG. 8B is a graph showing a data line as a target of analysis by the abnormality predictive pattern extraction unit, and FIG. 8C shows an abnormality predictive pattern table.

FIG. 9 is a flow chart of content registration processing according to the first embodiment of the present disclosure.

FIGS. 10A, 10B, 10C and 10D are views explaining a method of extracting an abnormality predictive pattern according to a second embodiment of the present disclosure, wherein FIG. 10A shows an abnormality pattern table, FIG. 10B is a graph showing representative value data as time series, FIG. 8C is a reference SPC graph, and FIG. 10D is an SPC graph in a temperature stabilizing step.

FIG. 11 is a view showing an abnormality predictive pattern table according to the second embodiment of the present disclosure.

### DETAILED DESCRIPTION

A first embodiment of the present disclosure will now be described.

### (1) Configuration of Substrate Processing Apparatus

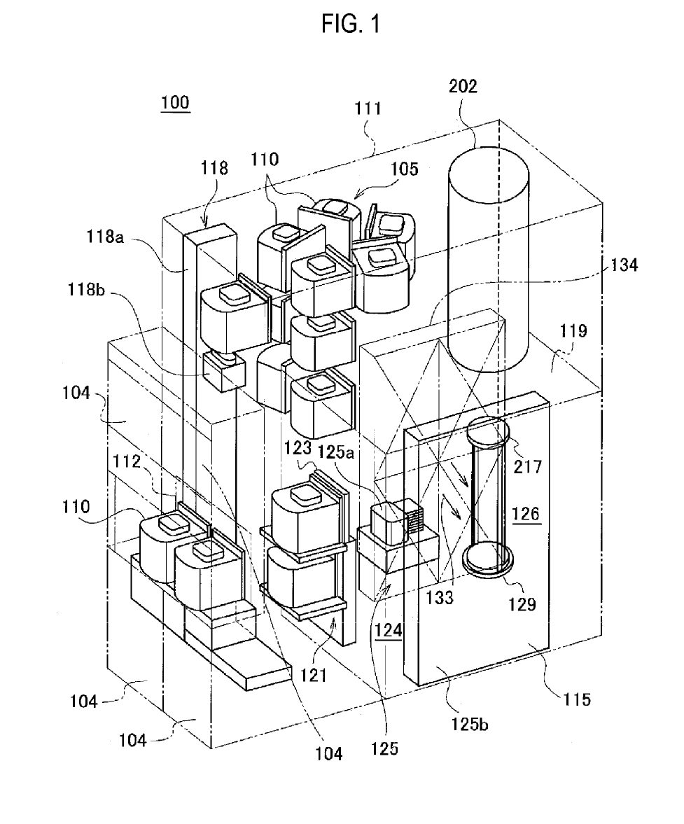

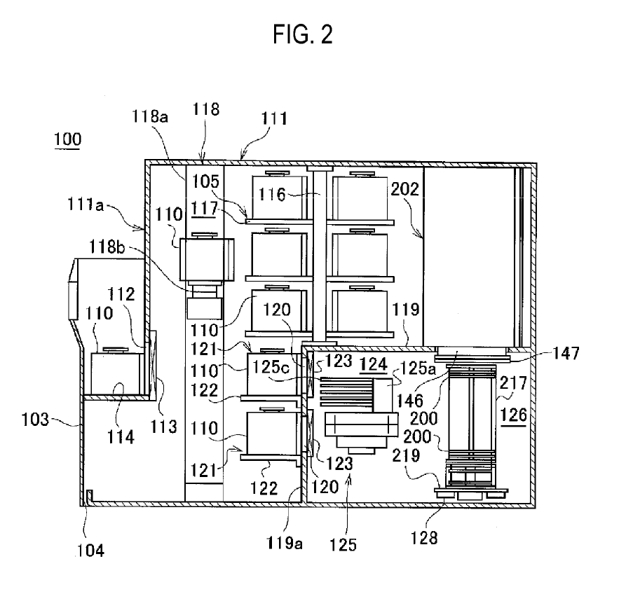

The configuration of a substrate processing apparatus 100 according to the present embodiment will be described with reference to FIGS. 1 and 2. FIG. 1 is a perspective view of the substrate processing subapparatus 100 according to the present embodiment, and FIG. 2 is a side sectional view of the substrate processing apparatus 100 according to the present embodiment. The substrate processing apparatus 100 according to the present embodiment is configured as a vertical type device for executing film formation, oxidization, diffusion and the like on a substrate such as, for example, a wafer or the like.

As shown in FIGS. 1 and 2, the substrate processing apparatus 100 according to the present embodiment includes a main body 111 configured as a pressure-resistant container. A front maintenance entrance 103 is provided as an opening allowing for maintenance at a front side of a front wall 111a of the main body 111. A front maintenance door 104 is provided at the front maintenance entrance 103 to open and close the front maintenance entrance 103.

In order to carry a wafer 200 as a substrate made of silicon (Si) or the like into or out of the main body 111, a pod 110 is used as a wafer carrier (substrate container) for receiving a plurality of wafers 200. A pod loading/unloading port (a substrate container loading/unloading port) 112 is formed to communicate with the interior and exterior of the main body 111 at the front wall 111a of the main body 111. The pod loading/unloading port 112 is opened and closed by a front shutter (substrate container loading/unloading port opening/closing mechanism) 113. A rod port (a delivery stage for transmitting and receiving the substrate container) 114 is provided at a front lower side of the pod loading/unloading port 112. The pod 110 is configured to be carried by a conveyance device (not shown) and mounted on the rod port 114 to be aligned thereon.

A pod conveyance device (substrate container conveyance device) 118 is provided in the vicinity of the rod port 114 within the main body 111. A rotary pod shelf (substrate container mounting shelf) 105 is provided at a further inner side of the pod conveyance device 118 within the main body 111, i.e., at an upper side of a substantially central portion in a horizontal direction within the main body 111. A pair of pod openers (substrate container lid opening and closing mechanism) 121 are arranged below the rotary pod shelf 105.

The pod conveyance device 118 includes a pod elevator (substrate container elevating mechanism) 118a that can ascend and descend with the pod 110 hold therein, and a pod conveyance mechanism (substrate container conveyance mechanism) 118b as a conveyance mechanism. The pod conveyance device 118 is configured to carry the pod 110 between the rod port 114, the rotary pod shelf 105, and the pod openers 121 by consecutive operations of the pod elevator 118a and the pod conveyance mechanism 118b.

The rotary pod shelf 105 may be configured to hold a plurality of pods 110 thereon. The rotary pod shelf 105 includes a supporting stmt 116 vertically arranged to be intermittently rotated in a horizontal plane, and a plurality of shelf boards (substrate container mounting tables) 117 radially supported by the supporting strut 116 at respective positions of upper, middle and lower stages of the supporting stmt 116. The plurality of shelf boards 117 are configured to be maintained with a plurality of pods 110 mounted thereon.

A sub-main body 119 is provided extending over a substantially central portion and a rear end portion in the horizontal direction at a lower portion in the main body 111, where the pod opener 121 is disposed. A pair of wafer loading/unloading ports (substrate loading/unloading ports) 120 for carrying the wafer 200 into or out of the sub-main body 119 are provided on a front wall 119a of the sub-main body 119. The pod openers 121 are provided at upper and lower wafer loading/unloading ports 120, respectively.

The respective pod openers 121 include a pair of mounting tables 122 for mounting the pod 110, and a cap attaching/detaching mechanism (lid member attaching/detaching mechanism) 123 for detachably attaching a cap (lid member) of the pod 110. The pod openers 121 are configured to open and close a wafer charging/discharging port of the pod 110 by detaching and attaching the cap of the pod 110 mounted on the mounting table 122 by the cap attaching/detaching mechanism 123.

In the sub-main body 119, a transfer chamber 124 is configured to be fluidically isolated from a space in which the pod conveyance device 118, the rotary pod shelf 105, and the like are provided. A wafer transfer mechanism (substrate transfer mechanism) 125 is provided at a front area of the transfer chamber 124. The wafer transfer mechanism 125 includes a wafer transfer device (substrate transfer device) 125a for rotating or directly moving the wafer 200 in a horizontal direction, and a wafer transfer device elevator (substrate transfer device elevating mechanism) 125b for lifting or lowering the wafer transfer device 125a. As shown in FIG. 1, the wafer transfer device elevator 125b is provided between a right end portion of a front area of the transfer chamber 124 of the sub-main body 119 and a right end portion of the main body 111. The wafer transfer device 125a includes a tweezer (substrate holder) 125c as a mounting member of the wafer 200. A notch alignment device (not shown) as a substrate alignment device for aligning the position of the wafer 200 in a circumferential direction is provided at the opposite side of the wafer transfer device elevator 125b with the wafer transfer device 125a interposed therebetween. The wafer 200 is configured to be loaded/unloaded (charged/discharged) into/from a boat 217 (to be described later) by consecutive operations of the wafer transfer device elevator 125b and the wafer transfer device 125a.

A standby region 126 for accommodating the boat 217 and making it standby is formed at a rear area of the transfer chamber 124. A processing furnace 202 for processing the wafer 200 is provided above the standby region 126. A lower end portion of the processing furnace 202 is configured to be opened and closed by a furnace port shutter (furnace port opening and closing mechanism) 147. Meanwhile, the configuration of the processing furnace 202 will be described later.

As shown in FIG. 1, a boat elevator (substrate holding member elevating mechanism) 115 for lifting and lowering the boat 217 is provided between a right end portion of the standby region 126 of the sub-main body 119 and a right end portion of the main body 111. An arm 128 as a coupling member is coupled to an elevating platform of the boat elevator 115. A seal cap 219 as a furnace lid member is horizontally provided on the arm 128. The seal cap 219 is configured to vertically support the boat 217 and close a lower end portion of the processing furnace 202.

The boat (substrate holding member) 217 includes a plurality of holding members. The boat 217 is configured to horizontally maintain a plurality of sheets (e.g., about 50 to 125 sheets) of wafers 200, respectively, in a state that the centers of the wafers are aligned in a vertical direction.

As shown in FIG. 1, a clean unit 134 including a dust-proof filter and a supply fan to supply clean air 133, as purified atmosphere or an inert gas, is provided at a left end portion, which is the opposite side of the wafer transfer device elevator 125b of the transfer chamber 124 and the boat elevator 115. The clean air 133 blown from the clean unit 134 is circulated along the periphery of the notch alignment device, the wafer transfer device 125a, and the boat 217 disposed in the standby region 126, and is then sucked by a duct (not shown) so as to be exhausted to the outside of the main body 111 or circulated up to a primary side (supply side), which is a suction side of the clean unit 134, and again blown into the transfer chamber 124.

### (2) Operation of Substrate Processing Apparatus

Next, the operation of the substrate processing apparatus 100 according to the present embodiment will be described with reference to FIGS. 1 and 2. The following operations are executed based on, for example, a conveyance recipe. The conveyance recipe is used to carry the wafer 200 within the substrate processing apparatus 100 and is applied to a substrate processing procedure, for example, together with a process recipe for executing substrate processing.

As shown in FIGS. 1 and 2, when the pod 110 is mounted on the rod port 114, the pod loading/unloading port 112 is opened by the front shutter 113. The pod 110 on the rod port 114 is loaded into the main body 111 by the pod conveyance device 118 through the pod loading/unloading port 112.

The pod 110 loaded into the main body 111 is automatically carried onto the shelf board 117 of the rotary pod shelf 105 by the pod conveyance device 118 to be temporarily held thereon. The pod 110 is then transferred onto the mounting table 122 of one pod opener 121 on the shelf board 117. The pod 110 loaded into the main body 111 may be transferred onto the mounting table 122 of the pod opener 121 directly by the pod conveyance device 118. The wafer loading/unloading port 120 of the pod opener 121 is closed by the cap attaching/detaching mechanism 123, and the clean air 133 circulates within the transfer chamber 124 to fill the transfer chamber 124. For example, the interior of the transfer chamber 124 is filled with the clean air 133 such as an inert gas or the like, making oxygen concentration within the transfer chamber 124, for example, 20 ppm or lower, which is significantly lower than the oxygen concentration within the main body 111 which is kept under atmospheric oxygen concentrations.

As for the pod 110 mounted on the mounting table 122, if an end surface of the pod 110 is pressed against an edge portion of the wafer loading/unloading port 120 provided on the front wall 119a of the sub-main body 119, the cap of the pod 110 is detached by the cap attaching/detaching mechanism 123 to open the wafer charging/discharging port. Thereafter, the wafer 200 is picked up from the interior of the pod 110 through the wafer charging/discharging port by the tweezer 125c of the wafer transfer device 125a and position-aligned in a circumferential direction by the notch alignment device, loaded into the standby region 126 behind the transfer chamber 124, and is loaded (charged) into the boat 217. After loading the wafer 200 into the boat 217, the wafer transfer device 125a is returned to the pod 110 and loads a next wafer 200 into the boat 217.

While the wafer 200 is being loaded into the boat 217 from one (upper or lower) pod opener 121 by the wafer transfer mechanism 125, another pod 110 is transferred by the pod conveyance device 118 from the upper portion of the rotary pod shelf 105 onto the mounting table 122 of the other (lower or upper) pod opener 121, so that an opening operation of the pod 110 is executed by the pod opener 121 simultaneously along with the loading operation of the wafer 200.

When a predetermined number of sheets of wafers 200 are loaded into the boat 217, the lower end portion of the processing furnace 202 which has been closed by the furnace port shutter 147 is opened. Subsequently, as the seal cap 219 is lifted by the boat elevator 115, the boat 217 holding a group of the wafers 200 therein is transferred (loaded) into the processing furnace 202.

After loading, predetermined processing is performed on the wafers 200 within the processing furnace 202. After the processing, the boat 217 holding the processed wafers 200 is unloaded from the processing furnace 202, and the pod 110 holding the processed wafer 200 is unloaded from the main body 111 in a sequence substantially reverse to the above-described operations, except for the position-alignment of the wafer by the notch alignment device.

### (3) Configuration of Processing Furnace.

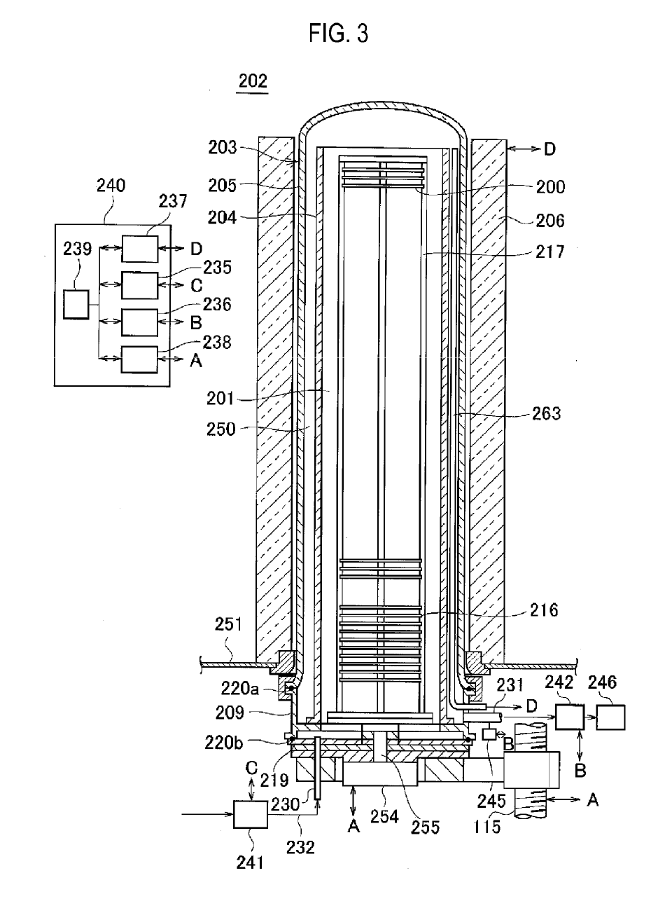

The configuration of the processing furnace 202 according to the present embodiment will now be described with reference to FIG. 3. FIG. 3 is a vertical sectional view of the processing furnace 202 of the substrate processing substrate processing apparatus 100 according to the present embodiment.

As shown in FIG. 3, the processing furnace 202 includes a process tube 203 as a reaction tube. The process tube 203 includes an inner tube 204 as an inner reaction tube and an outer tube 205 as an outer reaction tube provided at an outer side of the inner tube 204. The inner tube 204 is made of a heat-resistant material such as quartz (SiO₂), silicon carbide (SiC) or the like, and has a cylindrical shape with upper and lower ends opened. A processing chamber 201 for processing the wafer 200 as a substrate is formed in a cylindrical hollow portion within the inner tube 204. The interior of the processing chamber 201 is configured to accommodate the boat 217 to be described later. The outer tube 205 has a cross sectional shape of a concentric circle with the inner tube 204. The outer tube 204 has an inner diameter greater than an outer diameter of the inner tube 204 and has a cylindrical shape with an upper end sealed and a lower end opened. The outer tube 205 is made of a heat-resistant material such as, for example, quartz, silicon carbide, or the like.

A heater 206 is provided as a heating mechanism to surround a side wall surface of the process tube 203 at an outer side thereof. The heater 206 has a cylindrical shape and is supported by a heater base 251 as a holding plate so as to be vertically arranged.

A temperature sensor 263 as a temperature detector is provided within the process tube 203. A temperature controller 237 is electrically connected to the heater 206 and the temperature sensor 263. The temperature controller 237 is configured to adjust a current supplied to the heater 206 based on temperature information detected by the temperature sensor 263 such that the temperature within the processing chamber 201 has a desired temperature distribution at a desired timing.

A manifold 209 is provided at a lower side of the outer tube 205 to have a cross sectional shape of a concentric circle with the outer tube 205. The manifold 209 is made of, for example, stainless steel or the like, and has a cylindrical shape with upper and lower ends thereof opened. The manifold 209 is coupled to a lower end portion of the inner tube 204 and a lower end portion of the outer tube 205 to support them. Further, an O-ring 220a as a seal member is provided between the manifold 209 and the outer tube 205. The manifold 209 is supported by the heater base 251, such that the process tube 203 is vertically arranged. A reaction container is formed by the process tube 203 and the manifold 209.

The seal cap 219 as a furnace port lid member, which can air-tightly close the opening of the lower end of the manifold 209, is provided at a lower side of the manifold 209. The seal cap 219 comes into contact with the lower end of the manifold 209 from a lower side in a vertical direction. The seal cap 219 is made of a metal such as, for example, stainless steel or the like, and has a disk-like shape. An O-ring 220b as a seal member that is in contact with the lower end of the manifold 209 is provided on an upper surface of the seal cap 219. The seal cap 219 is configured to be lifted and lowered in a vertical direction by the boat elevator 115 as a substrate holding member elevating mechanism vertically provided at an outer side of the process tube 203. The boat 217 can be carried into or out of the processing chamber 201 by lifting or lowering the seal cap 219.

A rotating mechanism 254 for rotating the boat 217 is provided in the vicinity of a central portion of the seal cap 219 at the opposite side of the processing chamber 201. A rotational shaft 255 of the rotating mechanism 254 penetrates the seal cap 219 and supports the boat 217 from a lower side. The rotating mechanism 254 is configured to rotate the boat 217 and thus rotate the wafer 200.

A conveyance controller 238 is electrically connected to the boat elevator 115 and the rotating mechanism 254. The conveyance controller 238 is configured to control the rotating mechanism 254 and the boat elevator 115 such that they perform a desired operation at a desired timing. Additionally, the conveyance controller 238 is also electrically connected to the foregoing pod elevator 118a, the pod conveyance mechanism, the pod opener 121, the wafer transfer device 125a, the wafer transfer device elevator 125b, and the like to control them such that these elements perform a desired operation at a desired timing. Mainly, a conveyance system according to the present embodiment is configured by the boat elevator 115, the rotating mechanism 254, the pod elevator 118a, the pod conveyance mechanism 118b, the pod opener 121, the wafer transfer device 125a, and the wafer transfer device elevator 125b.

The boat 217 as a substrate holding member is configured to hold a plurality of sheets of wafers 200 horizontally stacked in multiple stages with the center of the wafers concentrically aligned. The boat 217 is made of, for example, a heat-resistant material such as quartz, silicon carbide, or the like. A plurality of insulating plates 216 are used as insulating members and have a disk-like shape. The insulating plates 216 are made of, for example, a heat-resistance material such as quartz, silicon carbide, or the like and are disposed to be horizontally stacked in multiple stages at a lower side of the boat 217 in order to restrain heat from the heater 206 from being transferred to the manifold 209.

A nozzle 230 as a gas introduction unit is connected to the seal cap 219 such that it communicates with the interior of the processing chamber 201. A downstream end of a gas supply pipe 232 is connected to an upstream end of the nozzle 230. One or a plurality of gas supply sources (not shown) such as a raw gas, an inert gas or the like, a mass flow controller (MFC) 241 as a gas flow rate controller, and a plurality of valves (not shown) are connected to the gas supply pipe 232 in order from the upstream side. A gas flow rate controller 235 is electrically connected to the MFC 241. The gas flow rate controller 235 is configured to control the MFC 241 such that a flow rate of a gas supplied into the processing chamber 201 has a desired flow rate at a desired timing. Mainly, a gas supply system according to the present embodiment is configured by the nozzle 230, the gas supply pipe 232, a plurality of valves (not shown), the MFC 241, and the gas supply source.

An upstream end of an exhaust pipe 231 for exhausting the atmosphere within the processing chamber 201 is connected to the manifold 209. The exhaust pipe 231 is disposed at a lower end portion of the cylindrical space 250 formed by a gap between the inner tube 204 and the outer tube 205, and communicates with the cylindrical space 250. A pressure sensor 245 as a pressure detector, an auto-pressure controller (APC) 242 as a pressure adjustment device, and a vacuum pump 246 as a vacuum exhaust device are connected at a downstream side of the exhaust pipe 231 in order from an upstream side. The APC 242 is a switching valve which is operable to open and close its valve to perform and stop vacuum exhaust within the processing chamber 201, and additionally adjusts an opening degree of the valve to adjust pressure. A pressure controller 236 is electrically connected to the APC 242 and the pressures sensor 245. The pressure controller 236 is configured to control the APC 242 such that the pressure within the processing chamber 201 has a desired pressure at a desired timing, based on a pressure value detected by the pressure sensor 245. Mainly, a gas exhaust system according to the present embodiment is configured by the exhaust pipe 231, the pressure sensor 245, the APC 242, and the vacuum pump 246.

The gas flow rate controller 235, the pressure controller 236, the temperature controller 237, and the conveyance controller 238 are electrically connected to a display device controller 239 for controlling the substrate processing apparatus 100 (hereinafter, the gas flow rate controller 235, the pressure controller 236, and the temperature controller 237 are also referred to as an I/O controller). The gas flow rate controller 235, the pressure controller 236, the temperature controller 237, the conveyance controller 238, and the display device controller 239 are included in a substrate processing apparatus controller 240. The configuration and operation of the substrate processing apparatus controller 240 will be described later.

### (4) Operation of Processing Furnace

A substrate processing procedure employing the processing furnace 202, which is executed as a part of the fabrication process of the semiconductor device, will now be described. The substrate processing procedure is repeatedly executed based on the process recipe for executing a predetermined processing on the wafer 200. Also, the process recipe may include a plurality of steps (processes). In the present embodiment, a film forming process of forming a thin film on the wafer 200 through a chemical vapor deposition (CVD) method will be described as an example of the substrate processing procedure based on the process recipe. Further, in the following description, the operations of respective parts constituting the substrate processing apparatus 100 are controlled by the substrate processing apparatus controller 240.

### (Substrate Loading Step)

First, a substrate loading step is executed. In particular, a plurality of sheets of wafers 200 are charged into the boat 217 (wafer charging), and the boat 217 holding the plurality of sheets of wafers 200 therein is lifted by the boat elevator 115 and loaded into the processing chamber 201 (boat loading). In this state, the seal cap 219 seals the lower end of the manifold 209 with the O-ring 220b interposed therebetween.

### (Film Forming Process)

Subsequently, a film forming process is performed on the wafers 200 by executing respective steps from a decompression step to a normal pressure restoration step. The respective steps from the decompression step to the normal pressure restoration step are included in the process recipe in the present embodiment. Further, the process recipe may include the substrate loading step or a substrate unloading step to be described later.

### (Decompression Step)

First, the processing chamber 201 is vacuum-exhausted by the vacuum pump 246 to have a desired pressure (vacuum degree) in the processing chamber 201. At this time, the opening degree of the valve of the APC 242 is feedback-controlled based on a pressure value measured by the pressure sensor 245.

### (Temperature Rising Step)

Next, the interior of the processing chamber 201 is heated by the heater 206 to have a desired temperature within the processing chamber 201. At this time, an amount of current supplied to the heater 206 is feedback-controlled based on the temperature value detected by the temperature sensor 263. Subsequently, the boat 217 and the wafers 200 are rotated by the rotating mechanism 254.

### (Temperature Stabilization Step)

Next, in a temperature stabilization step, the temperature within the heated processing chamber 201 is stabilized.

### (Film Forming Step)

When the temperature within the processing chamber 201 is stabilized, a valve (not shown) of the gas supply pipe 232 is opened to supply raw gas into the processing chamber 201 from a gas supply source by controlling a flow rate by the MFC 241. The raw gas flows upward within the processing chamber 201 and is discharged from the upper end opening of the inner tube 204 to the cylindrical space 250 so as to be exhausted from the exhaust pipe 231. When the raw gas passes through the interior of the processing chamber 201, it comes into contact with the surface of the wafer 200 and a thin film is deposited on the surface of the wafer 200 through a thermal CVD reaction. When a preset processing time has lapsed, the supply of raw gas into the processing chamber 201 is stopped.

### (Temperature Rising Step)

When the supply of raw gas is stopped, power supply to the heater 206 is stopped and the temperature of the boat 217 and the wafer 200 are lowered to a certain temperature.

### (Normal Pressure Restoration Step)

An inert gas is supplied from a gas supply source, and the interior of the processing chamber 201 is substituted with the inert gas and, at the same time, the pressure within the processing chamber 201 is returned to have a normal pressure. Accordingly, the film forming process based on the process recipe is terminated.

### (Substrate Unloading Step)

Thereafter, a substrate unloading step is executed. Specifically, the seal cap 219 is lowered by the boat elevator 115 to open the lower end of the manifold 209 and, at the same time, the boat 217 holding the processed wafer 200 therein is unloaded from the lower end of the manifold 209 to an outer side of the process tube 203 (boat unloading). The processed wafer 200 is taken out from the boat 217 and contained in the pod 110 (wafer discharging). Accordingly, the film forming process based on the process recipe is terminated.

### (5) Configuration of Substrate Processing Apparatus Controller

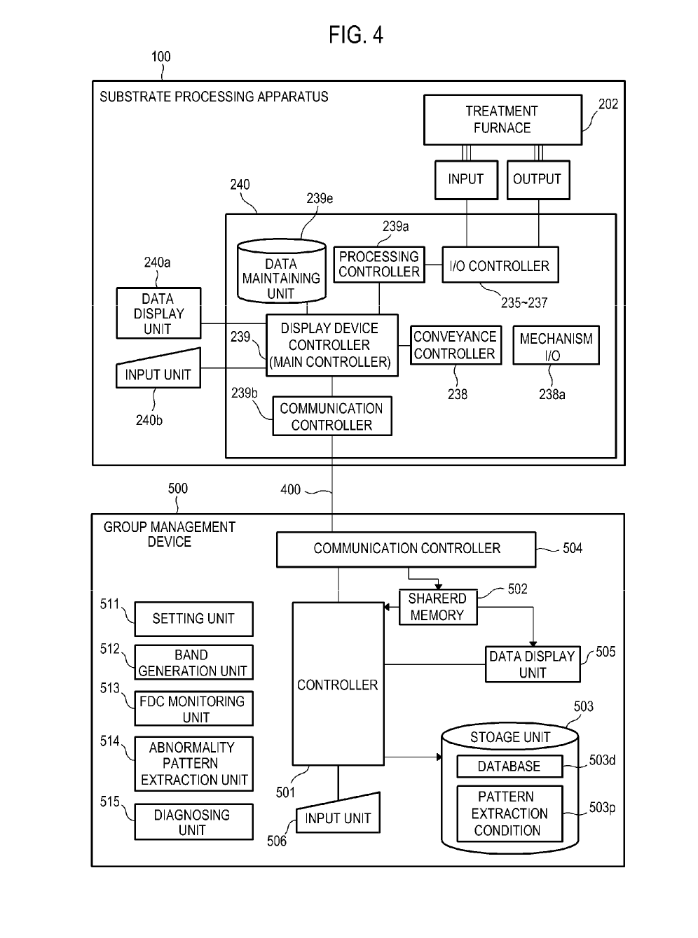

The configuration of the substrate processing apparatus controller 240 according to the present embodiment will now be described with reference to FIG. 4. FIG. 4 is a block diagram of a substrate processing system including the substrate processing 100 and a group management device 500 according to the present embodiment.

The substrate processing apparatus controller 240 includes a display device controller (manipulation unit) 239 as a main controller. A data display unit 240a such as a display or the like, and an input unit 240b such as a keyboard or the like are connected to the display device controller 239. The display device controller 239 is configured to receive an input (input of a manipulation command or the like) from the input unit 240b, which is manipulated by an operator, and to display a state display screen of the substrate processing apparatus 100, a manipulation input reception screen or the like on the data display unit 240a.

The substrate processing apparatus controller 240 includes a processing controller 239a connected to the display device controller 239 such that data can be exchanged therebetween. Also, the foregoing I/O controller components (the gas flow rate controller 235, the pressure controller 236, and the temperature controller 237) are connected to the processing controller 239a to control the processing furnace 202 such that data can be exchanged therebetween. The processing controller 239a controls the operation of the processing furnace 202 by using the I/O controller interposed therebetween and collect (read) monitor data indicating the state (temperature, gas flow rate, pressure, etc.) of the processing furnace 202.

Further, the substrate processing apparatus controller 240 includes a conveyance controller 238 connected to the display device controller 239 to exchange data therebetween and a mechanism I/O 238a connected to the conveyance controller 238 to exchange data therebetween. Respective parts (e.g., the boat elevator 115, the rotating mechanism 254, the pod elevator 118a, the pod conveyance mechanism 118b, the pod opener 121, the wafer transfer device 125a, the wafer transfer device elevator 125b, etc.) constituting the substrate processing apparatus 100 are connected to the mechanism I/O 238a. The conveyance controller 238 is configured to control the operations of the respective parts constituting the substrate processing apparatus 100 by using the mechanism I/O 238a interposed therebetween and collect (read) monitor data indicating the states (e.g., positions, switching state, whether the respective parts are operated or in a standby state, etc.) of the respective parts constituting the substrate processing apparatus 100. Specifically, the monitor data includes measurement data indicating an operation state of the substrate processing apparatus 100.

Also, the substrate processing apparatus controller 240 includes a data maintaining unit 239e connected to the display device controller 239. The data maintaining unit 239e is configured to maintain (store) programs for realizing various functions on the substrate processing apparatus controller 240, setting data (recipe data) of the substrate processing procedure executed in the processing furnace 202, various data read from the I/O controller (the gas flow rate controller 235, the pressure controller 236, the temperature controller 237) and the conveyance controller 238, or the like.

In addition, the substrate processing apparatus controller 240 includes a communication controller 239b connected to the display device controller 239. The communication controller 239b is configured to receive the monitor data indicating the state (temperature, gas flow rate, pressure, etc.) of the processing furnace 202 read by using the I/O controller (the gas flow rate controller 235, the pressure controller 236, the temperature controller 237) through the processing controller 239a and the display device controller 239, and transmit the received monitor data to the group management device 500. Also, the communication controller 239b is configured to receive monitor data indicating the states (e.g., positions, switching state, whether the respective parts are operated or in a standby state, etc.) of the respective parts constituting the substrate processing apparatus 100 read by using the mechanism I/O 238a through the conveyance controller 238 and the display device controller 239, and transmit the received monitor data to the group management device 500.

### (6) Configuration of Group Management Device

The configuration of the group management device 500 according to the present embodiment configured to exchange data with the foregoing substrate processing apparatus 100 will now be described with reference to FIG. 4.

As shown in FIG. 4, the group management device 500 is configured as a computer including a controller 501 configured as a central processing unit (CPU), a memory (not shown) having a shared memory area 502 therein, a storage unit 503 configured as a storage device such as a HDD or the like, a data display unit 505 as a display unit such as a display device or the like, an input unit 506 such as a keyboard or the like, and a communication controller 504 as a communication unit. The foregoing memory, the storage unit 503, the data display unit 505, the input unit 506, and the communication controller 504 are configured to exchange data with the controller 501 using an internal bus or the like interconnecting these units. Also, the controller 501 has a clock function (not shown).

### (Communication Controller)

The communication controller 504 as a communication unit is connected to the communication controller 239b of the substrate processing apparatus controller 240 and also connected to the I/O controller (the gas flow rate controller 235, the pressure controller 236, and the temperature controller 237) and the mechanism I/O 238a through a network 400. The communication controller 504 is configured to receive monitor data from the substrate processing apparatus 100 and transfer the received monitor data to the shared memory 502.

The communication controller 504 is configured to periodically receive monitor data at certain time intervals (e.g., at an interval of 0.1 seconds) as a reception timing of the monitor data, or receive the monitor data when each event occurs, e.g., at a timing when performing the recipe or a step is terminated, or whenever the monitor data is generated.

The monitor data transferred to the shared memory 502 is configured to be associated with a data ID identifying the monitor data, device-specific information (a device name or the like) specifying the substrate processing apparatus 100 as a generation source of the monitor data, recipe-specific information specifying a recipe which has been executed by the substrate processing apparatus 100 when the monitor data is generated, event-specific information specifying an event generated within the substrate processing apparatus 100 when the monitor data is collected, and time information (time data) indicating a time at which the monitor data is generated.

### (Storage Unit)

The storage unit 503 includes a database program, a representative value data generation program, a representative value data processing program, an FDC monitoring program, an abnormality pattern extraction program, and an abnormality predictive pattern extraction program stored respectively therein. The database program is read from the storage unit 503 and stored in the memory as described with reference to FIG. 4 (not shown) and executed in the controller 501, so as to realize a database 503d (to be described later) in the storage unit 503. The representative value data generation program is read from the storage unit 503 and stored in the memory as described with reference to FIG. 4 (not shown) and executed in the controller 501, so as to realize a representative value data generation unit 511 (to be described later) in the group management device 500. The representative value data processing program is read from the storage unit 503 and stored in the memory as described with reference to FIG. 4 (not shown) and executed in the controller 501, so as to realize a representative value data processing unit 512 (to be described later) in the group management device 500. The FDC monitoring program is read from the storage unit 503 and stored in the memory as described with reference to FIG. 4 (not shown) and executed in the controller 501, so as to realize an FDC monitoring unit 513 (to be described later) in the group management device 500. The abnormality pattern extraction program is read from the storage unit 503 and stored in the memory as described with reference to FIG. 4 (not shown) and executed in the controller 501, so as to realize an abnormality pattern extraction unit 514 (to be described later) in the group management device 500. The abnormality predictive pattern extraction program is read from the storage unit 503 and stored in the memory as described with reference to FIG. 4 (not shown) and executed in the controller 501, so as to realize an abnormality predictive pattern extraction unit 515 or an abnormality predictive pattern extraction unit 516 (to be described later) in the group management device 500. Further, the storage unit 503 stores a pattern extraction condition 503p as explained later to be read out.

The database 503d as a storing unit is configured to store the monitor data, which has been received by the communication controller 504 and stored in the shared memory 502, such that it is readable in association with each of the foregoing data ID, the device-specific information, the recipe-specific information, the event-specific information, and the time data, when the database program is executed.

The pattern extraction condition 503p is read out by the controller 501 when a condition regarding an interval for extracting monitor data as a basis of representative value data is received from the input unit 506. Such interval for extracting monitor data is related to the occurrence of a certain event within the substrate processing apparatus 100. As used herein, an event refers to a phenomenon occurring within the substrate processing apparatus 100, an operation of each part of the substrate processing apparatus 100, or the like. For example, the event may include one or more events occurring in time-series order according to execution of a recipe such as a switching operation of a valve, an ON/OFF operation of a sensor, generation of an abnormality, various manipulations by an operator or the like, in addition to an initiation and termination of performing a recipe or a step or the like, and any other event which is not necessarily based on the execution of a recipe.

As an example extraction condition for associating an interval for extracting monitor data with an occurrence of a certain event, the monitor data may be extracted during a period between certain events. The period between certain events may include, for example, a period from an initiation of execution of a certain recipe or a step to a termination of the execution, a period from an initiation of loading the wafer 200 to a termination of unloading the wafer 200, more specifically, a period from the initiation of charging the wafer 200 into the boat 217 in the foregoing substrate loading step to a period of termination of discharging the wafer 200 from the boat 217 in the substrate unloading step, and the like. In some embodiments, an extraction condition may be set to extract monitor data within a certain period according to the occurrence of a certain event (e.g., monitor data is extracted for 10 seconds starting from the opening of the valve), periodically extract monitor data starting from an occurrence of a certain event (e.g., monitor data is extracted at every 10 minutes starting from an initiation of electrical connection of the heater 206), extract monitor data during an interval from an occurrence of a certain event until a certain number of monitor data is obtained, or extract monitor data during an interval until the monitor data becomes a certain value. Also, a plurality of conditions including any combination of the above conditions may be set as the extraction condition.

Further, the pattern extraction condition 503p includes at least a monitor data table, a statistic table, and an abnormality determination rule table.

### (Representative Value Data Generation Unit)

When the pattern extraction condition 503p is read out according to an instruction from the input unit 506, the representative value data generation unit 511 reads out monitor data, which meet the monitor data extraction condition received from the input unit 506, among the monitor data stored in the database 503d, generates representative value data based on the read-out monitor data, and stores the generated representative value data along with time data (to be described later) in the database 503d realized in the storage unit 503 such that the generated representative value data can be read out later. The representative value data includes, for example, “representative value name” information indicating the name of a representative value, “representative calculation condition” information indicating a calculation condition of a representative value such as the types of statistics including an average, a maximum, a minimum or the like, “representative value extraction interval” information indicating an interval at which a representative value has been extracted, “representative value extraction date” information indicating start date and end date of the representative value extraction interval, “representative value” information indicating a representative value itself, “representative value generation date” information indicating date when a representative value has been generated, “representative value calculation time” information indicating time required for calculating a representative value, “data point” information indicating a data point used in calculating a representative value, and the like. The extraction condition of the monitor data as described above may be defined in the pattern extraction condition 503p in advance.

The representative value data generation unit 511 generates representative values such as a mean value, a maximum value, a minimum value, a standard deviation value and the like according to the types of statistics shown in a statistic table (to be described later) for every item of the monitor data shown in the monitor data table (to be described later).

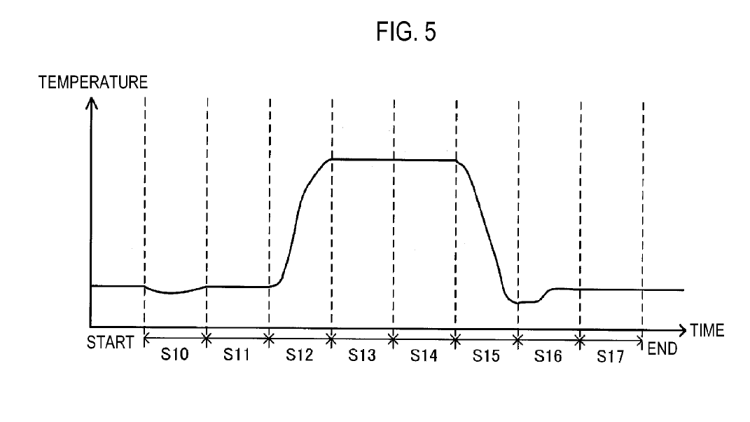

FIG. 5 is a time series graph showing that monitor data represents actual measurement values of the temperature of a heater of a U zone. It shows a graph of monitor data of the temperature obtained by executing processes through the substrate processing apparatus 100 based on the process recipe including the substrate loading step S10, the decompression step S11, the temperature rising step S12, the temperature stabilizing step S13, the film forming step S14, the temperature falling step S15, the normal pressure return step S16, and the substrate unloading step S17, as described above. In FIG. 5, the horizontal axis represents time, and the vertical axis represents an actual measurement value of the temperature of the heater. A method of generating representative value data by the representative value data generation unit 511 will be described with reference to FIG. 5. The representative value data generation unit 511 is configured to read out monitor data from the database 503d during a predetermined time period within a period from an execution start to an execution end of, for example, each process of S10 to S17 based on extraction conditions of the monitor data. Further, the representative value data generation unit 511 is configured to generate representative value data corresponding to the type of statistics shown in the statistic table (to be described later) with respect to each monitor data which has been read out. Time data indicating a generation time of the monitor data used as basis data is added to the generated representative value data, and a representative value data table is created and stored in the database 503d such that the stored representative value data table can be read out later.

If the storing of the representative value data and the time data in the database 503d is completed, the representative value data generation unit 511 is configured to transmit a ‘representative value data generation notification’ to the representative value data processing unit 512. In addition, communication between the representative value data generation unit 511 and the representative value data processing unit 512 is performed through, for example, the shared memory 502.

### (Representative Value Data Processing Unit)

The representative value data processing unit 512 is configured to read out the representative value data and the time data added to the representative value data from the database 503d and process the read data to display the processed data on the data display unit 505.

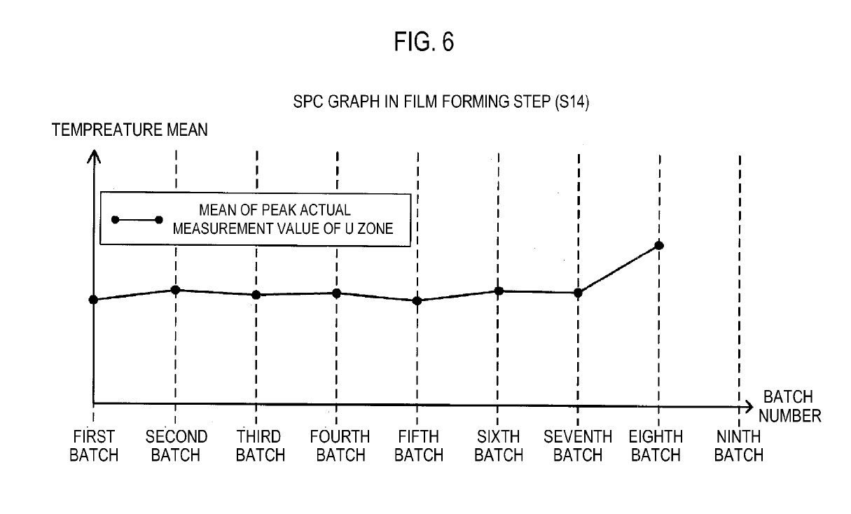

FIG. 6 is an example graph representing data values processed by the representative value data processing unit 512 and displayed on the data display unit 505. FIG. 6 is an SPC graph created based on an actual measurement value of the temperature of the heater of the U zone, which is an example of monitor data. The horizontal axis of the graph shown in FIG. 6 represents a batch number, and the vertical axis represents the representative value (temperature mean value) of the monitor data of the film forming step S14. In this graph, the batch number refers to the number of processing batches which have been repeatedly executed. Further, the SPC graph refers to a graph showing the statistics (representative values in each batch processing) arranged in time series as shown in FIG. 6. Thus, the graph as shown in FIG. 6 shows a change in the mean value of the temperatures of the heater of the U zone in the film forming step in each batch process.

Further, the representative value data processing unit 512 may be configured to process and display representative value data at a time in which a ‘representative value data display request’ is received according to a certain manipulation from the input unit 506, as well as at a time in which a ‘representative value data generation notification’ is received from the representative value data generation unit 511.

### (FDC Monitoring Unit)

The FDC monitoring unit 513 monitors the monitor data by using the SPC graph, and when the monitor data satisfies the abnormality determination rule (to be described later) shown in the abnormality pattern table, the FDC monitoring unit 513 determines that the monitor data is abnormal. In the present embodiment, the FDC monitoring unit 513 is used to detect an abnormality when extracting an abnormality pattern

### (Abnormality Pattern Extraction Unit)

If an abnormality (e.g., abnormality in film formation) is determined to occur according to the substrate processing results, the abnormality pattern extraction unit 514 is configured to analyze various monitor data using the SPC graph and extract a combination (pattern) of the monitor data, the statistics generated from the monitor data, and a condition (abnormality determination rule) used for determining the statistics. More specifically, if an abnormality is found in the N-th (where N is a natural number) batch process, the abnormality pattern extraction unit 514 analyzes the monitor data generated from the first batch up to the N-th batch in the abnormality generated process, and extracts a monitor data pattern that may be determined to be abnormal as an abnormality pattern.

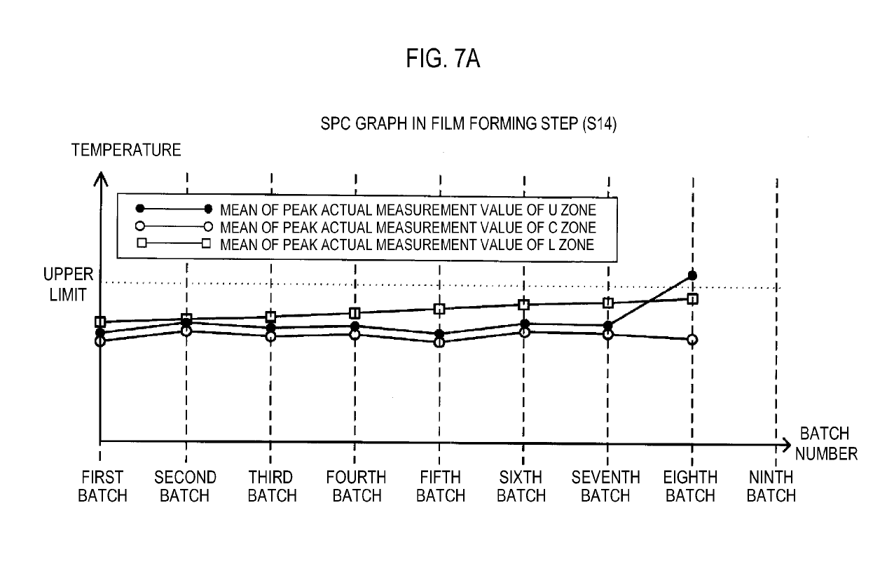

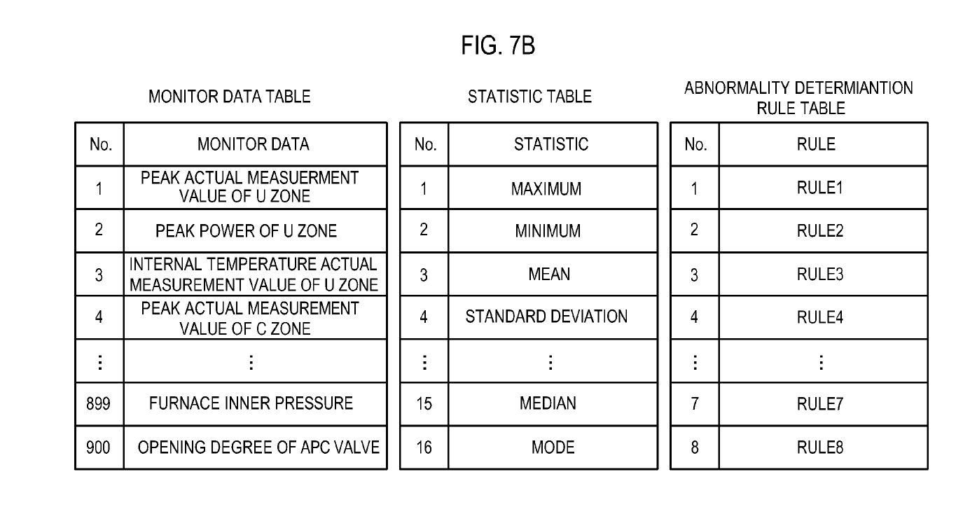

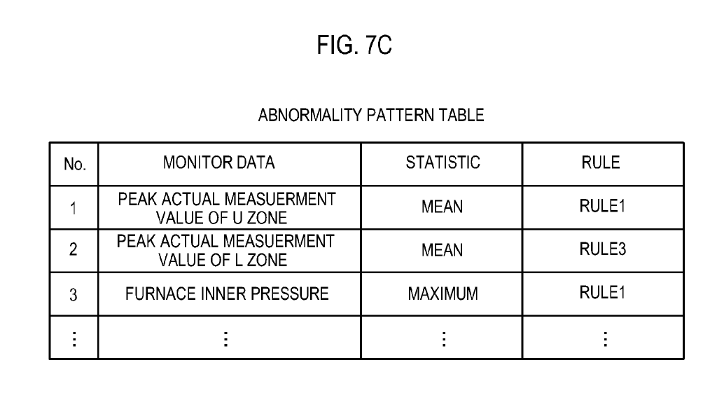

FIGS. 7A, 7B and 7C are views explaining a method for extracting an abnormality pattern. Referring to FIGS. 7A, 7B and 7C, a case in which an abnormality is generated in the film forming step in the eighth batch processing will be described as an example. FIG. 7A shows an SPC graph for the film forming step, which has been generated based on data from the first batch up to the eighth batch. Further, FIG. 7B shows a monitor data table, a statistic table, and an abnormality determination rule table used by the abnormality pattern extraction unit 514. In this embodiment, the monitor data table is a table stored for monitor data, for example, where an actual measurement value of a heater of a U zone, power of a heater of a C zone, an internal temperature actual measurement value of the U zone, an internal pressure of the processing furnace 202, and the like are stored as items of monitor data. The statistic table is a table which stores types of statistics used for generating a representative value by the representative value data generation unit 511. For example, a maximum value, a minimum value, a mean, and the like are stored as types of statistics in the statistic table. The abnormality determination rule table refers to a table which stores an abnormality determination rule for determining whether a change on standing of a representative value is abnormal. As the abnormality determination rule, for example, a rule defined by JIS Z9021 standard may be used. In the abnormality determination rule table as shown in FIG. 7B, for example, a first rule is defined by a condition in which “one data point exceeds a predetermined upper limit,” as an abnormality determination, a second rule is defined by a condition in which “nine data points are less than a predetermined value,” as an abnormality determination, and a third rule is defined by a condition in which “six data points are continuously increased,” and the like. FIG. 7C shows an abnormality pattern table which stores abnormality patterns extracted by the abnormality pattern extraction unit 514. Also, the monitor data table, the statistic table, the abnormality determination rule table, and the abnormality pattern table are stored in the database 503d such that they can be read out later.

The abnormality pattern extraction unit 514 analyzes monitor data for all possible combinations of data from the monitor data table, the statistic table, and the abnormality determination rule table as shown in FIG. 7B, and extracts a combination (pattern) of the monitor data satisfying the abnormality determination rule as shown in FIG. 7C. In other words, with reference to FIGS. 7A, 7B and 7C, the abnormality pattern extraction unit 514 calculates a representative value specified by the monitor data and the type of statistics for the monitor data at every batch, and extracts a combination of the monitor data, the statistics of the monitor data, and abnormality determination rules, satisfying the abnormality determination rule based on the SPC graph showing representative values calculated from the first batch to a batch having an abnormality in sequential time.

For example, the abnormality pattern extraction unit 514 combines an actual measurement value of the heater of the U zone, which is one of the monitor data, a mean value which is one type of statistic, and the first rule which is one of the abnormality determination rules, in the FDC monitoring unit 513, and determines whether the SPC graph of the mean value of the actual measurement value of the heater of the U zone satisfies the first rule (whether any one data point exceeds the predetermined upper limit). In this embodiment, in the time-series data for the respective processing batches shown in FIG. 7A, the mean value of the actual measurement value of the heater of the U zone in the eighth batch where an abnormality has been generated, exceeds the predetermined upper limit, which meets the condition of the first rule. The abnormality pattern extraction unit 514 stores such combination of data satisfying the above condition in the abnormality pattern table. Meanwhile, the abnormality pattern extraction unit 514 determines whether the abnormality determination rule is met by the representative value stored in the representative value data table of the database 503d.

The abnormality pattern extraction unit 514 does an analysis on every combination of data from the monitor data table, the statistic table, and the abnormality determination rule table, and stores any combination of data satisfying the abnormality determination rule in the abnormality pattern table.

Further, the abnormality pattern extraction unit 514 executes analysis on every combination of data. Also, when the abnormality pattern table is created, the abnormality pattern extraction unit 514 is configured to display the abnormality patterns stored in the abnormality pattern table on the data display unit 505.

An abnormality pattern used as content, among abnormality patterns displayed on the data display unit 505, is registered to the FDC monitoring unit 513 by an input (input of a manipulation command, or the like) from the input unit 506 according to a manipulation of an operator.

While, in the above description, the abnormality pattern extraction unit 514 analyzes every combination of data regarding the monitor data table, the statistic table, and the abnormality determination rule table, it may also analyze part of such combinations.

The abnormality pattern extracted by the abnormality pattern extraction unit 514 is obtained by monitoring a change in the monitor data, which is made when an abnormality occurs, based on the SPC. Thus, such abnormality pattern has high reliability for use as the content. An operator may simply select to use content from the abnormality pattern extracted by the abnormality pattern extraction unit 514 and re-register it to the FDC monitoring unit 513, whereby appropriate content can be easily registered. In this manner, according to the present embodiment, a combination of data, in which statistics of the monitor data is determined to be abnormal, can be automatically extracted as an abnormality pattern from all possible combinations of data including the monitor data (900 data), the statistics (16 data), and the abnormality determination rules (eight types of rules). Thus, a cause of an (film formation) abnormality can be determined from the abnormality pattern.

However, in relation to the analysis by the abnormality pattern extraction unit 514 in the foregoing example, the abnormality pattern extraction unit 514 analyzes the data when an abnormality is found to actually occur in the film forming step in a posteriori manner. Thus, although the related pattern is registered as content, there remains a possibility that a film formation abnormality has been already generated when the FDC monitoring unit 513 detects such abnormality. That is, if inappropriate content is used for the analysis, a film formation abnormality may be unnecessarily repeated, which increases unnecessary production cost.

For this reason, for example, when there is a limitation in the number of contents that can be registered to the FDC monitoring unit 513, the operator may need to selectively register more valid content, by which abnormality can be predicted before such abnormality actually occurs, among the abnormality patterns extracted by the abnormality pattern extraction unit 514.

In the present embodiment, the abnormality predictive pattern extraction unit 515 extracts content by which abnormality can be detected before the abnormality is actually generated.

### (Abnormality Predictive Pattern Extraction Unit)

For example, while an abnormality occurs in the eighth batch, a precursor leading to the abnormality may appear in the seventh batch. Thus, the abnormality predictive pattern extraction unit 515 re-analyzes whether an abnormality can also be detected from a previous batch before the batch where the abnormality occurs, by using the abnormality pattern stored in the abnormality pattern table created by the abnormality pattern extraction unit 514. A pattern extracted through the re-analysis by the abnormality predictive pattern extraction unit 515 has a higher possibility of detecting an abnormality before its actual generation, in comparison to the other abnormality patterns which are not extracted at this stage. Thus, the extracted abnormality pattern is registered as content and can be used to prevent a film formation abnormality in advance.

The abnormality predictive pattern extraction unit 515 is different from the abnormality pattern extraction unit 514, in that it analyzes the data of the preceding batch processing before the batch processing where an abnormality actually occurs. Further, while the abnormality pattern extraction unit 514 analyzes all possible combinations of data from the monitor data table, the statistic table, and the abnormality determination rule table, the abnormality predictive pattern extraction unit 515 analyzes only the combination of data stored in the abnormality pattern table.

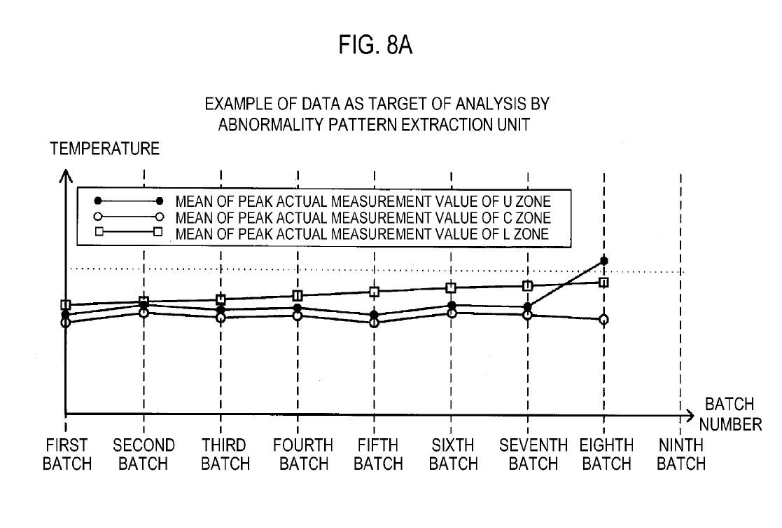

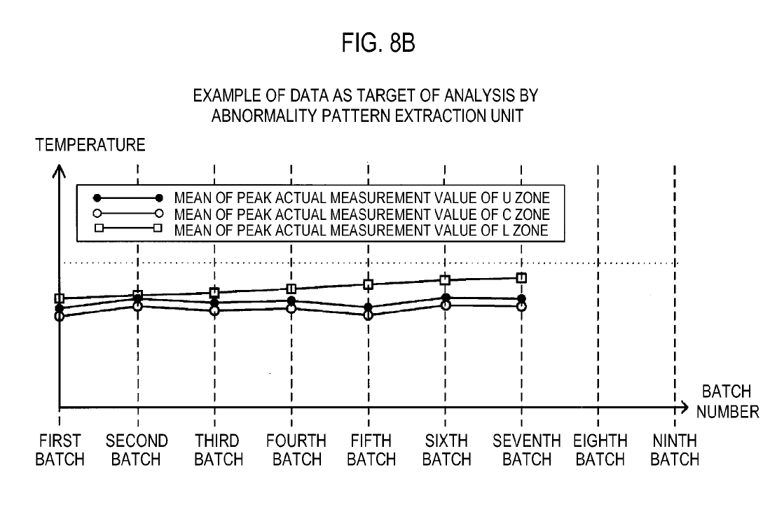

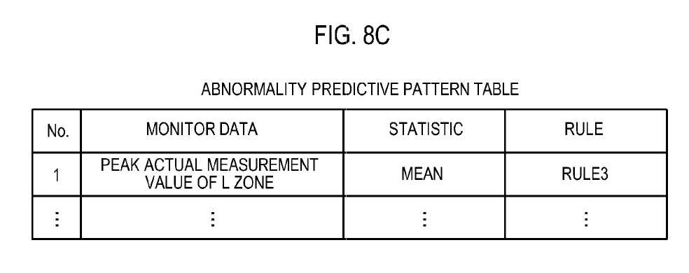

FIGS. 8A, 8B and 8C are views explaining the difference between the abnormality pattern extraction unit 514 and the abnormality predictive pattern extraction unit 515. In particular, FIG. 8A shows an example of a data line as a target of analysis executed by the abnormality pattern extraction unit 514, and FIG. 8B shows an example of a data line as a target of analysis executed by the abnormality predictive pattern extraction unit 515. Further, FIG. 8C shows an abnormality predictive pattern table which stores an abnormality predictive pattern extracted by the abnormality predictive pattern extraction unit 515. As shown in FIGS. 8A, 8B and 8C, these drawings illustrate, by way of example, a case in which a film formation abnormality is generated in the eighth batch, depicted in an SPC graph of a mean value of the actual measurement value of the heater. As shown in FIG. 8A, the abnormality pattern extraction unit 514 analyzes the data for the first batch up to the eighth batch in which a film formation abnormality actually occurs. On the other hand, the abnormality predictive pattern extraction unit 515 analyzes the data for the first batch up to the seventh batch, as shown in FIG. 8B.

Further, according to the data line as shown in FIG. 8A, a mean value of the actual temperature measurement values of the heater in the L zone (represented along the vertical axis) is continuously increased from the third batch to the eighth batch. Therefore, this pattern of data meets the third rule (i.e., six data points are continuously increased) among the foregoing abnormality determination rules. Thus, as shown in item 3 of the table in FIG. 7C, the abnormality pattern extraction unit 514 extracts a combination of data including “the actual measurement value of the heater of the L zone, the mean value, and the third rule” as an abnormality pattern and stores the pattern in the abnormality pattern table.

Also, according to the data sequence as shown in FIG. 8A, the mean value of the actual temperature measurement values of the heater of the L zone (represented along the vertical axis) is also continuously increased from the second batch to the seventh batch. Therefore, although the same analysis as performed by the abnormality pattern extraction unit 514 is executed on the data sequence as a target of analysis by the abnormality predictive pattern extraction unit 515, as shown in FIG. 8B, the third rule can also be applied. Thus, as shown in FIG. 8C, the abnormality predictive pattern extraction unit 515 stores the combination of data including “the actual measurement value of the heater of the L zone, the mean value, and the third rule” as an abnormality predictive pattern in the abnormality predictive pattern table. The abnormality predictive pattern table is stored in the database 503d such that the stored table can be read out later.

The abnormality predictive pattern extraction unit 515 analyzes the data of the preceding batch processing before the batch processing where an abnormality actually occurs, with respect to all abnormality patterns stored in the abnormality pattern table. Also, when a combination (abnormality pattern) of data satisfying the abnormality determination rule is found, the abnormality predictive pattern extraction unit 515 stores such combination of data as an abnormality predictive pattern in the abnormality predictive pattern table. When the analysis with respect to all of the abnormality patterns stored in the abnormality pattern table is completed, the abnormality predictive pattern extraction unit 515 is configured to display the abnormality predictive pattern stored in the abnormality predictive pattern table on the data display unit 505.

In addition, an abnormality predictive pattern used as content among the abnormality predictive patterns displayed on the data display unit 505 is registered to the FDC monitoring unit 513 according to an input (input of a manipulation command, or the like) from the input unit 506 through a manipulation of an operator.

Thus, the operator may be able to register content for determining abnormality prediction to the FDC monitoring unit 513, before an abnormality actually occurs in substrate processing, by simply selecting a pattern among abnormality predictive patterns presented by the abnormality predictive pattern extraction unit 515.

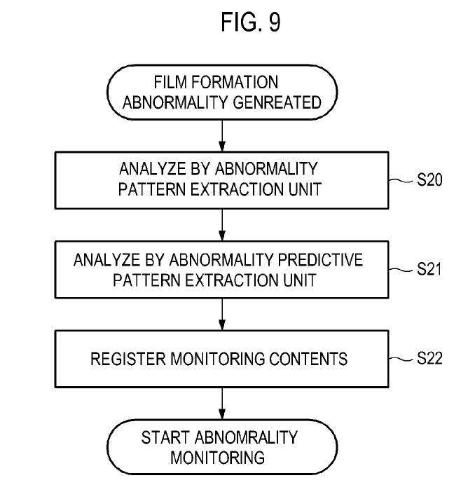

FIG. 9 is a flow chart of a content registration processing according to one embodiment. In particular, FIG. 9 shows the content registration processing executed in a time period starting from the occurrence of an actual abnormality in the substrate processing to the start of monitoring based on the registered content.

First, in step S20, the abnormality pattern extraction unit 514 analyzes monitor data of a batch processing, where an abnormality occurs, and the preceding batch processing prior to the batch processing associated with the abnormality. Also, this analysis is performed with respect to a process (step) in which the abnormality has occurred in sequential operations of substrate processing, based on a combination of data from the monitor data table, the statistic table, and the abnormality determination rule table. Further, in step S20, an abnormality pattern table which stores the abnormality pattern obtained through the analysis is created, and the process proceeds to step S21.

In step S21, the abnormality predictive pattern extraction unit 515 analyzes the monitor data obtained in the preceding batch processing, rather than the abnormality-associated batch processing in the related process (step), based on the combination of data stored in the abnormality pattern table. Also, in step S21, an abnormality predictive pattern table which stores the abnormality predictive pattern obtained through analysis is created, and the process proceeds to step S22.

In step S22, the operator may select a pattern among the list of abnormality patterns from the abnormality pattern table or the list of abnormality predictive patterns from the abnormality predictive pattern table displayed on the data display unit 505. The selected pattern is registered as the content to the FDC monitoring unit 513.

When the content is registered to the FDC monitoring unit 513, the FDC monitoring unit 513 checks monitor data based on the registered content and starts abnormality detection regarding the substrate processing.

In this manner, the monitor data can be monitored based on appropriately selected content, and thus an unnecessary detection of a film formation abnormality can be avoided. In addition, since a precursor of abnormality occurrence can be detected from the previous batch processing data, unnecessary production cost can be reduced.

Next, a second embodiment of the present disclosure will be described.

The present embodiment has the same configuration as the first embodiment, except that it includes an abnormality predictive pattern extraction unit 516, rather than the abnormality predictive pattern extraction unit 515.

Hereinafter, the abnormality predictive pattern extraction unit 516 according to the present embodiment will be described.

According to the first embodiment, the abnormality predictive pattern extraction unit 515 analyzes the data of the preceding batches before the batch where an abnormality occurs, in relation with the abnormality-associated step. However, the abnormality predictive pattern extraction unit 516 of the present embodiment analyzes the data of the preceding batches before the batch where an abnormality occurs, in relation with a preceding step before the abnormality-associated step. For example, if an abnormality occurs in the M-th (where M is a natural number) step constituting sequential processes of the substrate processing in the N-th (where N is a natural number) batch, the abnormality predictive pattern extraction unit 515 of the first embodiment analyzes the monitor data for the M-th step of the first to the (N−1)-th batches. On the other hand, the abnormality predictive pattern extraction unit 516 of the present embodiment analyzes the monitor data for the (M−1)-th step of the first to the N-th batches as a target of the analysis.

The abnormality predictive pattern extraction unit 516 considers the pattern determined through the analysis as an abnormality predictive pattern and creates an abnormality predictive pattern table which stores the abnormality predictive pattern.

For example, in the film forming step, when an abnormality occurs, it is likely that a precursor that might have led to the generation of an abnormality has been shown in a preceding step of the film forming step. Thus, the abnormality predictive pattern extraction unit 516 executes an analysis to check whether an SPC graph having data in strong correlation with the SPC graph of the abnormality pattern extracted by the abnormality pattern extraction unit 514 has been generated for the preceding step of the step in which the abnormality has occurred. In this embodiment, when the preceding step with such strong correlation is found and an abnormality of the monitor data has occurred in a subsequent step, it is highly likely that an abnormality will actually occur in a further subsequent step. Thus, the contents associated with the SPC graph having the strong correlation may be registered to the FDC monitoring unit 513, thereby stopping the process recipe performed for the preceding step of the step in which an abnormality actually occurs. This can prevent a further generation of an abnormality in actual processing.

More specifically, the abnormality predictive pattern extraction unit 516 executes the following processing on every abnormality pattern stored in the abnormality pattern table, based on a reference SPC graph specified by the abnormality pattern. As used herein, the reference SPC graph represents a representative value for the process in which an abnormality occurs, and more specifically, a representative value specified by the related abnormality pattern (combination of data). For example, if it is assumed that the step in which an abnormality occurs is a film forming step, with respect to an abnormality pattern including a combination of “the actual measurement value of the heater of the U zone, the mean value, and the third rule,” the reference SPC graph indicates that a mean value of an actual temperature measurement value of the heater of the U zone is a representative value specified by the abnormality pattern, and also denotes the corresponding representative value for the film forming step.

First, the reference SPC graph is created from one of the abnormality patterns stored in the abnormality pattern table.

Next, the SPC graph indicating a representative value specified by the corresponding abnormality pattern is generated for all preceding process before the process in which the abnormality has occurred. Then, a correlation coefficient between the generated SPC graphs and the reference SPC graph is calculated.

If an SPC graph, for which the corresponding correlation coefficient is greater than a predetermined value, is found, the abnormality predictive pattern extraction unit 516 stores the abnormality pattern of the corresponding reference SPC graph in the abnormality predictive pattern table.

The above processing is repeatedly performed on the remaining abnormality patterns stored in the abnormality pattern table.

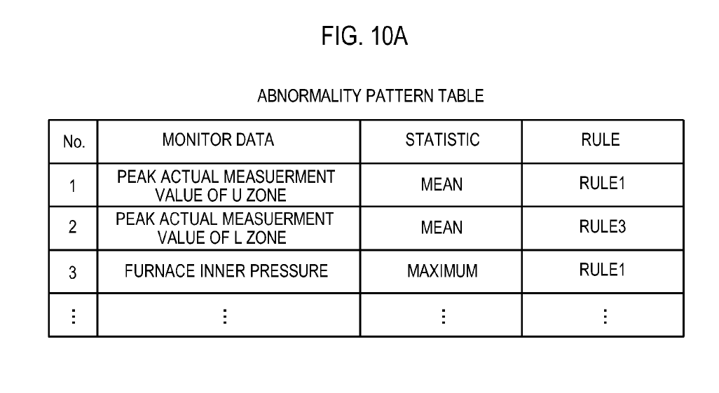

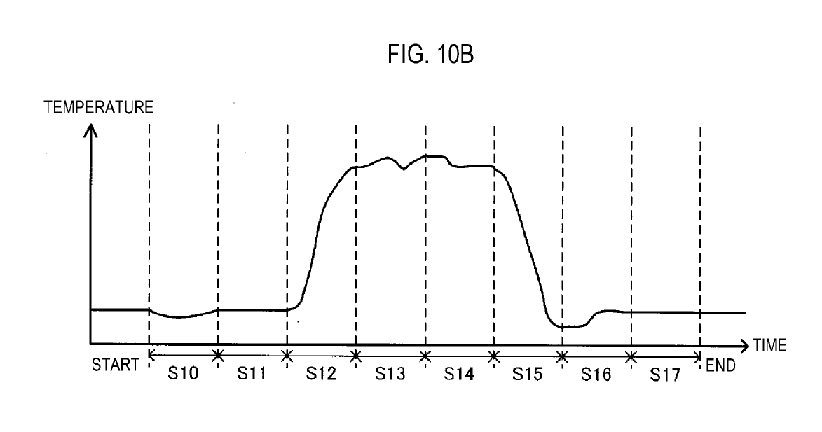

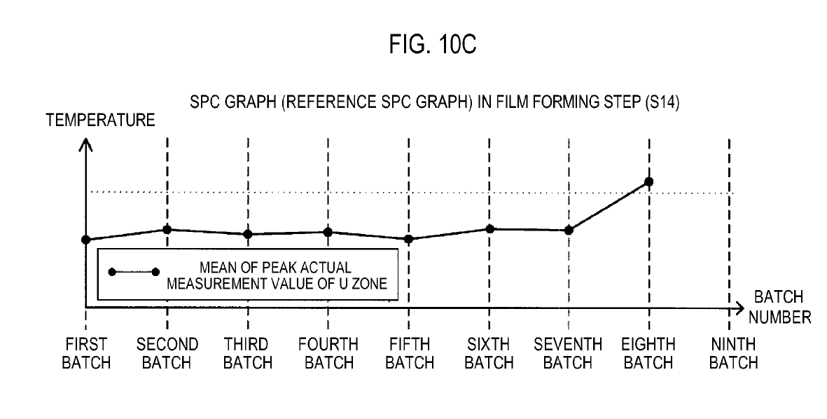

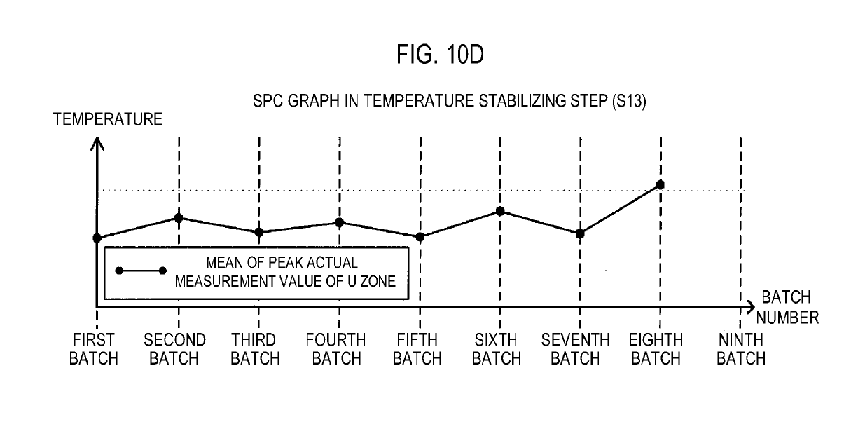

FIGS. 10A, 10B, 10C and 10D are views explaining a method of extracting an abnormality predictive pattern through the abnormality predictive pattern extraction unit 516. With reference to FIGS. 10A, 10B, 10C and 10D, a case in which a film formation abnormality actually occurs at the eighth batch in the film forming step, similar to the first embodiment, will be described in detail as an example. FIG. 10A shows an abnormality pattern table extracted by the abnormality pattern extraction unit 514, and FIG. 10B is a graph showing a change in representative values in the eighth batch in which a film formation abnormality occurs.

FIG. 10C is a reference SPC graph generated for one of the abnormality patterns stored in the abnormality pattern table. Specifically, this SPC graph shows a reference SPC graph for the film forming step with respect to an abnormality pattern including a combination of “the actual temperature measurement value of the heater of the U zone, the mean value, and the third rule” among the abnormality patterns stored in the abnormality pattern table shown in FIG. 10A. FIG. 10D is an SPC graph generated for a temperature stabilizing step which is a process executed immediately before the film forming step. That is, FIG. 10D shows a graph of a mean of the actual temperature measurement values of the heater of the U zone, similar to the graph in FIG. 10C.

The abnormality predictive pattern extraction unit 516 calculates a correlation coefficient between the reference SPC graph illustrated in FIG. 10C and the SPC graph for the temperature stabilizing step illustrated in FIG. 10D. Specifically, the abnormality predictive pattern extraction unit 516 calculates a correlation coefficient by using a total of 8 data points from the first batch to the eighth batch in which an abnormality has occurred.

If the correlation coefficient exceeds a predetermined value, e.g., 0.8, the abnormality predictive pattern extraction unit 516 stores the abnormality pattern including the combination of “the actual temperature measurement value of the heater of the U zone, the mean value, and the third rule” as an abnormality predictive pattern in the abnormality predictive pattern table.

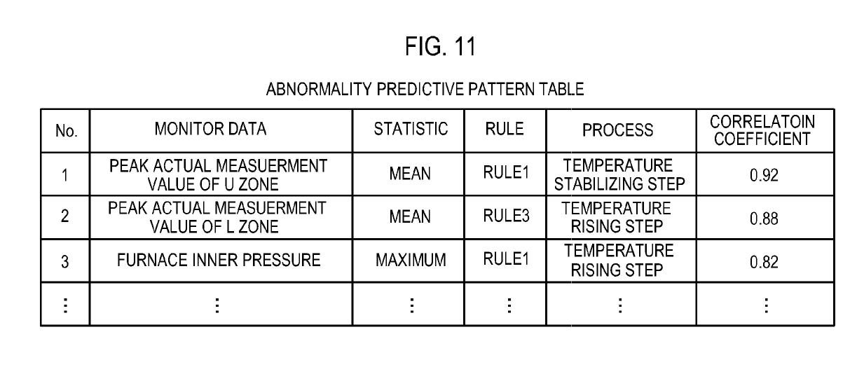

FIG. 11 shows an example of the abnormality predictive pattern table generated by the abnormality predictive pattern extraction unit 516. As shown in FIG. 11, a type of preceding step for which the correlation coefficient is 0.8 or greater, and the value of the correlation coefficient may also be stored together with the abnormality predictive pattern in the abnormality predictive pattern table.

In the foregoing description with reference to FIGS. 10A, 10B, 10C and 10D, only the temperature stabilizing step is described as a preceding step immediately before the film forming step. However, as shown in FIG. 10B, the substrate loading step (S10), the decompression step (S11), the temperature rising step (S12), in addition to the temperature stabilizing step (S13), may be performed before the film forming step (S14). Thus, the above-described processing may be executed for all of these steps.

Further, with respect to the reference SPC graph generated for the abnormality pattern including the combination of “the actual temperature measurement value of the heater of the U zone, the mean value, and the third rule,” when the extraction of the abnormality predictive pattern by calculating the correlation coefficient is completed for all preceding steps before the film forming step, an abnormality predictive pattern is also extracted for the abnormality patterns stored in the abnormality pattern table by calculating the correlation coefficient in the same manner.

The abnormality predictive pattern table extracted by the abnormality predictive pattern extraction unit 516 may be displayed on the data display unit 505 in the same manner as performed in the first embodiment. Also, an abnormality predictive pattern used as content, among the abnormality predictive patterns displayed on the data display unit 505, is registered to the FDC monitoring unit 513 according to an input by the operator from the input unit 506.

In the above description, the reference SPC graph is created for all of the abnormality patterns stored in the abnormality pattern table and a correlation coefficient with respect to an SPC graph of the preceding steps is obtained. However, this process may be performed on only part of the abnormality patterns in the abnormality pattern table. Also, only part of the preceding steps, rather than all of the preceding steps of the film forming step, may be considered in this process.

While the above processing is performed until it reaches the content registration according to the present embodiment is the same as the process flow illustrated in FIG. 9, the processing of step S22 in FIG. 9 is performed as follows.

In the present embodiment, in step S21, a correlation coefficient in association with an SPC graph for a preceding step of the process in which an abnormality occurs is obtained based on the reference SPC graph specified by the respective abnormality patterns stored in the abnormality pattern table by the abnormality predictive pattern extraction unit 516. Further, if the correlation coefficient exceeds a predetermined value, the corresponding abnormality pattern is stored as an abnormality predictive pattern in the abnormality predictive pattern table.

Also, in the present embodiment, similar to the first embodiment, the operator may be able to register content for determining a precursor of an abnormality before an abnormality actually occurs in substrate processing, to the FDC monitoring unit 513, by simply selecting such content from a list of the abnormality predictive patterns.

In another embodiment of the present disclosure, a configuration having both the abnormality predictive pattern extraction unit 515 described in the first embodiment and the abnormality predictive pattern extraction unit 516 described in the second embodiment may be provided.

Also, in some embodiments, the management device may not be disposed on the same floor (clean room) as that of the substrate processing apparatus, and the management device may be disposed, for example, in an office through a LAN connection. Furthermore, in the management device, the storage unit (database), the controller, the input unit, and the data display unit are not required to be integrated but may be separately configured to remotely analyze data of the database disposed on the clean room through an input unit (terminal device) located in an office.

In addition, even an apparatus for processing a glass substrate, such as an LCD device, as well as a semiconductor manufacturing apparatus, may be applied as the substrate processing apparatus. Also, similarly, an etching apparatus, an exposing apparatus, a lithography apparatus, a coating apparatus, a mold apparatus, a developing apparatus, a dicing apparatus, a wire bonding apparatus, an inspection apparatus, or the like as a substrate processing may be applied.

Further, the film forming processing includes, for example, CVD, PVD, ALD, Epi, processing for forming an oxide film or a nitride film, processing for forming a film including metal, and the like. Also, the film forming processing may include processing such as annealing, an oxidization, a diffusion, and the like.

While the present disclosure has been shown and described with respect to the particular embodiments, it is to be understood by those skilled in the art that the present disclosure is not limited thereto but various changes may be made without departing the gist of the present disclosure.

The present disclosure features the matters described in claims, but the following matters are added as additional aspects of the present disclosure.

(1) A substrate processing system, including a predictive extraction unit for further extracting a combination of data for determining a precursor of an abnormality occurrence in processing by the substrate processing apparatus from among the combination of data extracted by the extraction unit.

(2) The substrate processing system, wherein the predictive extraction unit analyzes the combination of data extracted by the extraction unit by using measurement data of processing executed before the processing in which an abnormality occurs, in the processing repeatedly performed by the substrate processing apparatus, and extracts the combination of data for determining the precursor of an abnormality occurrence.

(3) The substrate processing system, wherein the predictive extraction unit obtains a correlation coefficient between the statistics of the measurement data including the combination of data extracted by the extraction unit and the statistics of the measurement data for at least one preceding process of the process in which an abnormality occurs, among the processes constituting the processing by the substrate processing apparatus, and compares the correlation coefficient with a predetermined threshold value to extract the combination of data for determining the precursor of an abnormality occurrence.

(4) A management device, including a storage unit for storing a type of a measurement target regarding an operation state, a type of statistic applied to measurement data, and a type of condition used for determining the statistics applied to the measurement data, a first extraction unit for analyzing the measurement data by a combination of data including the measurement target, the statistics, and the condition stored in the storage unit, and extracting a combination of data indicating an abnormality of the measurement data, and a second extraction unit for extracting a combination of data for determining a precursor of an abnormality occurrence by the substrate processing apparatus from combinations of data extracted by the first extraction unit.

(5) A method for monitoring a substrate processing apparatus executed by the management device for monitoring the substrate processing apparatus, by using at least one combination of data selected from the combinations of data extracted by the first extraction unit or the combinations of data extracted by the second extraction unit.

According to the embodiments of the present disclosure, it is possible to extract content appropriate for analyzing a huge amount of past monitor data, and to shorten the time required for analyzing the monitor data in the occurrence of an abnormality.

Further, according to the embodiments of the present disclosure, if an abnormality in data generated as a predetermined processing result (e.g., abnormality in film formation), different factors causing the same abnormality may not be distinguished based on specific monitor data. Thus, it is necessary to determine whether monitor data and statistics of the monitor data shows abnormality trends. According to the embodiments of the present disclosure, a combination of data showing such abnormality trends can be easily extracted.

Further, according to the embodiments of the present disclosure, statistics for respective monitor data are extracted, and it is determined which abnormality determination rules are applied with respect to such statistics. In this manner, since a combination of data including monitor data, the statistics applied to the monitor data, and a condition used in determining the statistics is automatically extracted, a proper combination of data can be generated without relying on the operator's capability and experience. While, in the related art, a combination of data is required to be prepared and set in advance, the accuracy of such combination of data significantly depends on the operator's capability. Thus, the combination of data of the related art does not provide accuracy in a consistent manner. Further, if the combination of data provides poor accuracy, it may be difficult to determine which one out of accumulated monitor data being analyzed has caused an abnormality in data generated as a processing result. However, the present disclosure addresses such problems.

While certain embodiments have been described, these embodiments have been presented by way of example only, and are not intended to limit the scope of the disclosure. Indeed, the novel methods and apparatuses described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A management apparatus comprising:
an accumulation unit configured to accumulate measurement data regarding an operation state of a substrate processing apparatus;
a storage unit configured to individually store the measurement data, a type of statistics applied to the measurement data, and a condition used for determining the statistics; and
an extraction unit configured to extract a combination of data for which the measurement data accumulated in the accumulation unit is determined to be abnormal, with respect to a combination of data including the measurement data, the statistics, and the condition stored in the storage unit.

2. The management apparatus of claim 1, further comprising a predictive extraction unit configured to extract a combination of data for determining a precursor of an abnormality occurrence in processing by the substrate processing apparatus from the combination of data extracted by the extraction unit.

3. The management apparatus of claim 2, wherein the predictive extraction unit analyzes the combination of data extracted by the extraction unit by using measurement data of processing executed before the processing in which an abnormality occurs in the processing repeatedly performed by the substrate processing apparatus to extract the combination of data for determining the precursor of an abnormality occurrence.

4. The management apparatus of claim 2, wherein the predictive extraction unit obtains a correlation coefficient between the statistics of the measurement data including the combination of data extracted by the extraction unit and the statistics of the measurement data for the process before the process in which an abnormality occurs, among the processes constituting the processing by the substrate processing apparatus, and compares the correlation coefficient with a predetermined threshold value to extract the combination of data for determining the precursor of an abnormality occurrence.

5. A substrate processing system including a substrate processing connected to the management apparatus defined in claim 1.

6. A data analysis method comprising:
collecting measurement data regarding an operation state of a substrate processing apparatus; and
extracting a combination of data for which the measurement data is determined to be abnormal in a predetermined time range, among the collected measurement data, with respect to a combination of data including the measurement data, a statistics applied to the measurement data, and a condition used for determining the statistic.

7. The data analysis method of claim 6, further comprising:
extracting a combination of data for determining a precursor of an abnormality occurrence in processing by the substrate processing apparatus, by using measurement data of processing executed before the processing in which an abnormality occurs, for the combination of data for which the measurement data is determined to be abnormal.

8. An abnormality data extraction program comprising:
extracting a combination of data for which measurement data regarding an operation state of a substrate processing apparatus is determined to be abnormal in a predetermined time range, among the measurement data, with respect to a combination of data including the measurement data, a statistics applied to the measurement data, and a condition used for determining the statistic.
